(19) United States
(12) Patent Application Publication
(10) Pub. No.: US 2024/0204438 A1
(43) Pub. Date: Jun. 20, 2024

(54) HIGH VOLTAGE ELECTRICAL TERMINAL WITH COMPLIANT CONTACT INSERT

(71) Applicant: Aptiv Technologies AG, Schaffhausen (CH)

(72) Inventors: Nicholas A. DURSE, Youngstown, OH (US); Matthias Brands, Wuppertal (DE); Adam Wolfgang, Petersburg, OH (US)

(21) Appl. No.: 18/544,967

(22) Filed: Dec. 19, 2023

Related U.S. Application Data
(60) Provisional application No. 63/433,822, filed on Dec. 20, 2022.

(51) Int. Cl. H01R 13/24; H01R 13/187; H01R 13/502; H01R 13/53; H01R 13/639

(52) U.S. Cl. CPC H01R 13/2492; H01R 13/187; H01R 13/502; H01R 13/53; H01R 13/639

(57) ABSTRACT

A high-voltage electrical connector is described. The connector includes a U-shaped retainer and a spring that extends from a wall of the U-shaped retainer and applies a normal force to couple a terminal to a mating terminal in the high voltage electrical connector. The connector further includes a contact insert configured to be arranged between the terminal and the mating terminal. The contact insert includes an array of resilient protrusions that operate in conjunction with at least one projection that extends from the terminal to establish a plurality of connection points between the terminal and the mating terminal.

### CROSS-REFERENCE TO RELATED APPLICATION

This application claims benefit of priority to U.S. Provisional Patent Application No. 63/433,822 filed on Dec. 20, 2022, the entire disclosure of which is hereby incorporated by reference.

### TECHNICAL FIELD

This disclosure is generally directed to high voltage electrical terminals and more particularly to a high voltage electrical terminal with improved coupling performance.

### BACKGROUND

It is known to use electrical terminals capable of carrying electrical current in excess of 100 amperes at voltages greater than 60 volts in electric vehicles (EVs) and hybrid-electric vehicles (HEVs). In addition, as internal combustion engine (ICE) vehicles become more electrified to reduce emission of greenhouse gasses, electrical terminals require increasingly robust and reliable designs.

FIG. 1 illustrates a prior high voltage electrical connector 100 that includes a generally planar terminal 102 and a U-shaped retainer 104. The electrical connector 100 further includes a resilient spring 106 that is located between the retainer 104 and the terminal 102. A planar mating terminal (not shown) is received within a gap between the spring 106 and the terminal 102 and the spring 106 provides a contact force between these terminals. The terminal 102 includes a pair of oblong contact bumps 108 that make electrical contact with the mating terminal. Typically, two or three contact points are made between the contact bumps 108 and the mating terminal due to surface imperfections on the mating faces of the terminals. Because the physical size of each of these contact points is very small, the total contact resistance between the terminal 102 and the mating terminal is typically in the range of 20 to 30 micro-ohms with contact force between the terminals of about 50 newtons. In order to reduce this contact resistance, the terminals may be plated with a low electrical resistance material, such as silver or gold, to lower contact resistance. However, this extra plating undesirably increases time and costs required to manufacture the high voltage electrical terminal. The electrical connector 100 may be used to terminate copper electrical bus bars. As the length of the bus bar increases, the difficulty and cost of selectively plating the ends of the bus bar forming the terminal also increases. Aluminum bus bars may be used in place of copper bus bars, however, the plating of the ends of the aluminum bus bars is even more challenging and costly than copper bus bars.

Lamella contact inserts, such as those shown in U.S. Pat. No. 10,230,191, have also been used in prior high voltage terminal designs to provide multiple contact points for low electrical resistance while also functioning as a contact spring to provide the contact force. The lamella contact inserts are formed from a copper-based material in order to provide a low resistance connection. However, the spring force of the lamella contact inserts has an inherent tendency to relax when the copper-based material is subjected to elevated temperatures, such as those experienced when conducting high currents through the terminal.

### SUMMARY

Various embodiments of a high voltage electrical connector are described that offer improvements over traditional high-voltage connectors in that they incorporate both rigid and flexible contact surfaces that work together to enable a plurality of coupling points of the connector. In some examples, the described connector enables electrical coupling of high-voltage terminals with low contact resistance and improved resilience to unintended decoupling.

For example, high-voltage electrical connector is described. The high-voltage electrical includes a U-shaped retainer, and a spring that extends from a wall of the U-shaped retainer and applies a normal force to couple a terminal to a mating terminal in the high-voltage electrical connector. The high-voltage electrical connector further includes a contact insert configured to be arranged between the terminal and the mating terminal, wherein the contact insert includes an array of resilient protrusions that operate in conjunction with at least one projection that extends from the terminal to establish a plurality of connection points between the terminal and the mating terminal.

As another example, a bus bar terminal is described. The bus bar terminal includes a planar surface configured to be coupled with a mating terminal by a connector comprising a U-shaped retainer with spring that applies a normal force on the bus bar terminal and the mating terminal. The bus bar terminal further includes a contact insert secured to the planar surface that includes an array of resilient protrusions that operate in conjunction with at least one projection that extends from planar surface to establish a plurality of connection points between the bus bar terminal and the mating terminal.

As another example, a method of assembling an electrical connector is described. The method includes providing a U-shaped retainer with a spring that extends from a wall of the U-shaped retainer and applies a normal force to couple a terminal to a mating terminal. The method further includes arranging a contact insert between the terminal and the mating terminal, wherein the contact insert includes an array of resilient protrusions that operate in conjunction with at least one projection that extends from the terminal to establish a plurality of connection points between the terminal and the mating terminal.

### BRIEF DESCRIPTION OF THE DRAWINGS

The present invention will now be described, by way of example with reference to the accompanying drawings, in which:

FIG. 1 is an isometric view of a high voltage electrical connector according to the prior art.

FIG. 2 is an isometric view of a high voltage electrical connector according to some embodiments.

FIG. 3 is a partial top isometric view of the high voltage electrical terminal of FIG. 2 according to some embodiments.

FIG. 4 is a partial end isometric view of the high voltage electrical terminal of FIG. 2 according to some embodiments.

FIG. 5 is a partial side isometric view of the high voltage electrical terminal of FIG. 2 according to some embodiments.

FIG. 6 is an isometric view of an alternative example of the high voltage electrical terminal with a contact insert that includes an array of resilient positive and negative protrusions according to some embodiments.

FIG. 7 is an isometric view of an alternative example of the high voltage electrical terminal with a contact insert that includes an array of resilient positive and negative protrusions according to some embodiments.

FIG. 8 is an isometric view of an alternative example of the high voltage electrical terminal with a contact insert that includes an array of resilient cantilevered protrusions according to some embodiments.

FIG. 9 is an isometric view of an alternative example of the high voltage electrical terminal with a contact insert that includes an array of resilient cantilevered protrusions according to some embodiments.

FIG. 10 is an isometric view of an alternative example of the high voltage electrical terminal with a contact insert that includes an array of resilient cantilevered protrusions according to some embodiments.

FIG. 11 is an isometric view of an alternative example of the high voltage electrical terminal with a contact insert that includes an array of resilient louvre protrusions according to some embodiments.

FIG. 12 is a graph of the total contact resistance of the contact insert vs. the number of contacts between a contact insert and a terminal of the high voltage electrical terminal of FIG. 2.

FIG. 13 is a chart of the contact resistance and contact force of each pair of positive and negative protrusions in a contact insert and a terminal of the high voltage electrical terminal of FIG. 2.

FIG. 14 is a flow diagram depicting a method of manufacturing an electrical terminal assembly according to some embodiments.

### DETAILED DESCRIPTION

This disclosure is directed to improvements in electrical connectors, specifically electrical connectors that support coupling of high-voltage electrical terminals, such as electrical bus bars associated with an electric, hybrid, or gas-powered vehicle. According to the various examples described herein, a high-voltage electrical terminal incorporates a contact insert and is adapted to provide both rigid and compliant contact surfaces that each operate to improve an electrical connection between high-voltage terminals.

In some examples, providing an electrical connector that includes both rigid and flexible contact surfaces may represent significant advantages in comparison to known high-voltage electrical connectors. In some examples the rigid and flexible contact surfaces provide many contact points to provide a current path at the connector interface (e.g., between respective terminals of the connector). For example, the electrical connector may be resilient to unintended disconnection or malfunction when exposed to high-temperature and/or high currents. In some examples, the described electrical connector is particularly resilient to overstress. For example, the rigid and flexible contact surfaces may be designed in such a way as to limit the flexible contact surfaces from being overstressed and potentially damaged or caused to malfunction. In some examples, the described electrical connector may be less expensive and/or easier to manufacture than traditional bus bars. For example, the electrical connector may support coupling of bus bars with resilience to overstress that have little or no aluminum or copper plating.

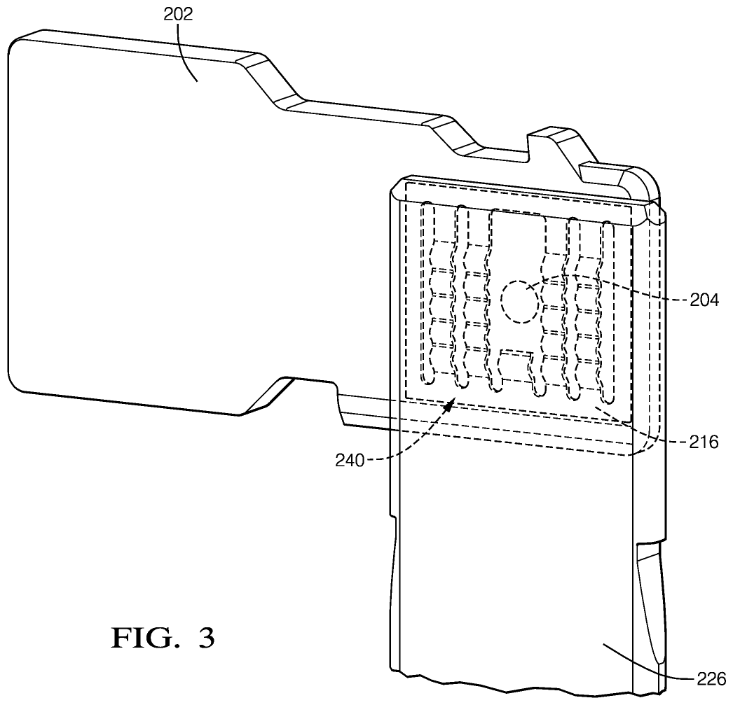

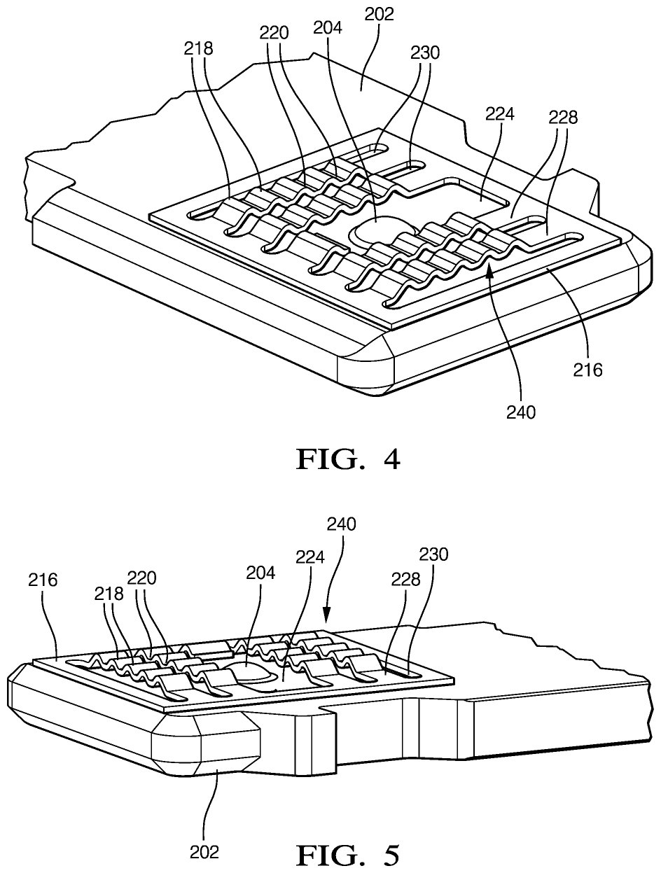

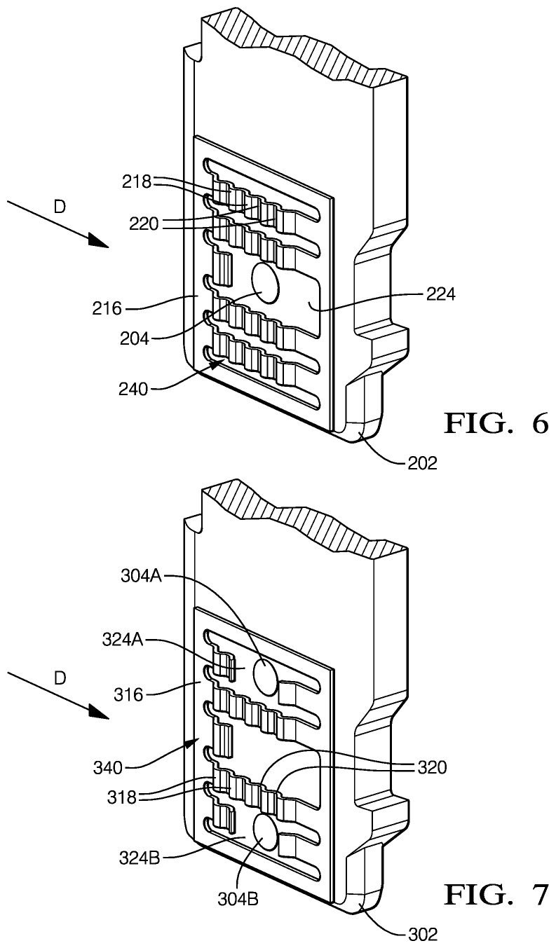

FIG. 2 is an isometric view of a high voltage electrical connector 200 that includes a contact insert 216 according to several embodiments. FIG. 3 is a partial top isometric view of a high voltage electrical terminal 202, a mating terminal 226, and a contact insert 216 that includes an array of positive and negative protrusions according to some embodiments. FIG. 4 is a partial end isometric view of the high voltage electrical terminal 202 according to some embodiments. FIG. 5 is a partial side isometric view of the high voltage electrical terminal 202 according to some embodiments. FIG. 6 is an alternative side isometric view of the high voltage electrical terminal 202 according to some embodiments.

Electrical connector 200 is illustrated in FIGS. 2 and 3 and includes a generally planar terminal 202, such as the end of a copper bus bar conductor. In alternative embodiments, the terminal may be formed of aluminum, such as the end of an aluminum bus bar. A U-shaped retainer 206 has a first side wall 208 that is attached to the terminal 202. The retainer 206 also has a second side wall 210 that is separated from and is arranged substantially parallel to the first side wall 208. The retainer 206 further includes an end wall 212 interconnecting the first side wall 208 and the second side wall 210. The terminal 202 is arranged so that is located between the first side wall 208 and the second side wall 210. The retainer 206 is preferably formed of a high strength material, such as steel.

The terminal 202 includes at least one projection 204 protruding therefrom. In the illustrated example, the projection 204 is an embossment formed in or on the terminal 202 having a spherical sector or domed shape. In some embodiments the projection 204 may be formed in or on the mating terminal 226. A resilient spring 214 is attached to the second side wall 210 of the retainer and is arranged between the second side wall 210 and the terminal 202. The spring 214 may be formed from a material that is less susceptible to relaxation due to temperature, such as a stainless steel material.

The electrical connector 200 also includes a planar contact insert 216 that is separate and distinct from the spring 214 and the terminal 202. The contact insert 216 is disposed intermediate the spring 214 and the terminal 202 and is preferably attached to the terminal 202 or mating terminal 226 by a laser welding process or some other welding process.

In the example of FIGS. 2-5, contact insert 216 defines an array 240 which includes resilient positive and negative protrusions 218, 220. The positive protrusions 218 extend from the contact insert 216 toward a gap 222 between the spring 214 and the contact insert 216 and the negative protrusions 220 extend from the contact insert 216 toward the terminal 202. The contact insert 216 also defines an opening 224 through which the projection 204 extends through a generally central location in the contact insert 216. The contact insert 216 is formed from a material having a low electrical resistance, such as a copper-based material having a resistance of less than 100 micro-ohms/meter. The contact insert 216 may be formed from a sheet of a copper-based material having a thickness of 0.3 to 0.5 millimeters. The spring 214 is configured to exert a normal connection force on the terminal 202 and a planar mating terminal 226 inserted into the gap 222 between the spring 214 and the contact insert 216. The projection 204 and the array of resilient positive and negative protrusions 218, 220 provide a plurality of electrical contact points between the terminal 202 and the mating terminal 226. Since the spring 214 provides the majority of the contact force, the copper material forming the contact insert 216 can be a softer material. The positive and negative protrusions 218, 220 are configured to yield and conform to the terminal 202 and mating terminal 226 once the mating terminal 226 is inserted within the electrical connector 200, thereby creating an array of additional contact points between the terminal 202 and the mating terminal 226 with balanced contact forces. The positive and negative protrusions 218, 220 may be designed to yield at a predetermined maximum contact force. Higher protrusions in the array of resilient positive and negative protrusions 218, 220 are plasticly deformed while lower protrusions are elastically deformed, thereby providing the balanced contact force. The height of the projection 204 may also be selected to limit compression of the resilient positive and negative protrusions 218, 220 and thereby inhibit overstress of the resilient positive and negative protrusions 218, 220.

In some examples, welding the negative protrusions 220 of the contact insert 216 to the terminal 202 using a laser welding or resistance welding process beneficially reduces the contact resistance and secures the contact insert 216 within the electrical connector 200. The contact insert 216 has a plurality of strips 228 that form the array of resilient positive and negative protrusions 218, 220 and a plurality of slots 230 between the strips 228. In other embodiments, the negative protrusions 220 of the contact insert 216 may be welded to the to the mating terminal 226.

In the example of the contact insert 216 shown in FIGS. 4 and 5, the plurality of strips 228 each have a wavy or undulating shape that forms the array of resilient positive and negative protrusions 218, 220.

Other embodiments of the contact insert may be envisioned in which edges of the strips are embossed to form the array of resilient positive and negative protrusions. These embossments form each protrusion in the shape of a spherical quadrant. The negative protrusions, may be welded to the terminal 202 to further reduce the contact resistance between the terminal 202 and the mating terminal 226.

The contact insert 216 is preferably made from a thin stock, high conductivity plated copper. The contact insert 216 conforms to surface and alignment irregularities of the terminal 202 and mating terminal 226, thereby creating an array of contact points with balanced contact forces. The contact points are designed to yield, settling in at a predetermined maximum contact force, higher protrusions on the contact insert 216 yield while lower protrusions remain elastic. These balance out to maintain a consistent contact force. The projection 204 and the array of resilient positive and negative protrusions 218, 220 form a number of parallel circuit paths through contact points R_{point 1} to R_{point n}: between the terminal 202 and the contact insert 216. Therefore, the total resistance Rₜₒₜₐₗ between the terminal 202 and the mating terminal 226 is equal to the inverse of the sum of the inverse of the point resistance of each of the contact points R_{point 1} to R_{point n} as shown in Equation 1 below:

$${R}_{t o t a l} = \frac{1}{( \frac{1}{{R}_{p oint 1}} + \frac{1}{{R}_{p oint 2}} … + \frac{1}{{R}_{p oint n}} )} \qquad Equation 1$$

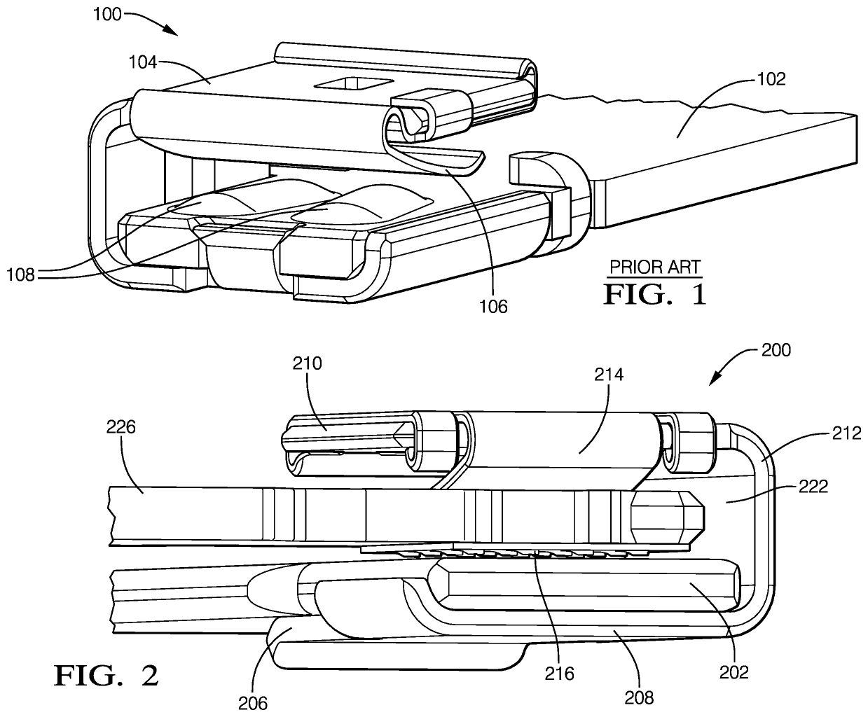

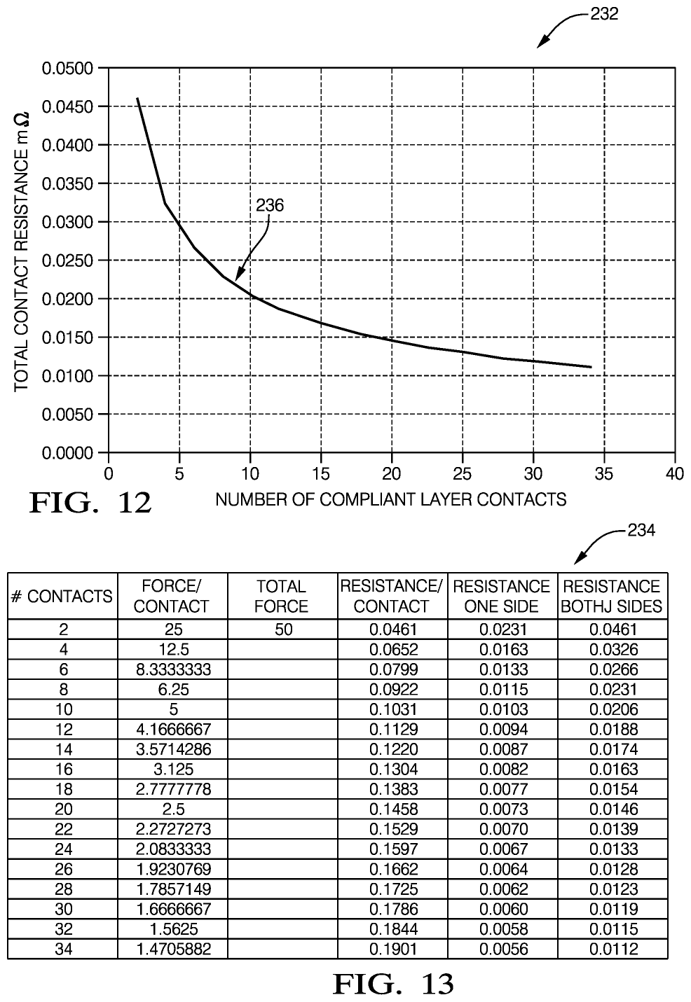

Therefore, the total resistance Rₜₒₜₐₗ between the terminal 202 and the mating terminal 226 decreases as the number n of contact points between the terminal 202 and the mating terminal 226 increases as shown in the graph 232 of FIG. 12 and the table 234 of FIG. 13. As can be seen, there is an inflection point 236 when the number n of contact points exceeds 10 to 15. The total resistance of 20 contact points is 25% to 50% lower than two contact points as provided by the prior art terminal illustrated in FIG. 1. The contact insert 216 eliminates the need to plate the terminal 202 with silver or gold as was needed with the prior art terminal 100 illustrated in FIG. 1.

A copper contact plate having only the array of negative protrusions (not shown) may be plated with silver or gold and laser or resistance welded to a portion of the mating terminal 226 that interfaces with the contact insert 216 to further eliminate the need to add silver or gold plating to the mating terminal 226. Plating operations require specialized manufacturing facilities, so the terminal 202 and/or mating terminal 226 must be transported to the plating operation, whereas laser or resistance welding of the contact insert 216 is more suitable to utilize at the point of manufacture of the electrical connector 200, thereby reducing manufacturing costs.

While in the illustrated example, the at least one projection 204 protrudes from the terminal 202, alternative embodiments of the electrical connector assembly may be envisioned in which at least one projection protrudes from the mating terminal 226 and the opening in the contact insert 216 is a slot in which the at least one projection on the mating terminal 226 is received.

FIGS. 7-11 each depict examples of the electrical terminals that may be used as part of electrical connector 200 depicted in FIG. 2. The various terminals 302, 402, 502, 602, and 702 depicted in FIGS. 7-11 may each be substituted for terminal 202 in the connector of FIG. 2. As set forth in further detail below, each of terminals 302, 402, 502, 602, and 702 incorporates a respective contact insert 316, 416, 516, 616, 716 and includes both rigid and flexible contact surfaces that operate in conjunction to establish a mechanical and electrical coupling of connector 200. For example, the rigid and flexible contact surfaces may present respective forces opposed to a normal force applied by spring 214 to improve coupling with a mating terminal 226 as depicted in FIGS. 2 and 3. In some examples, the connectors that incorporate one or more of the various contact inserts 216, 316, 416, 516, 616, 716 described herein may eliminate the need to add silver, gold, or other plating to the mating terminal 226.

FIG. 7 depicts embodiment of a terminal 302 that includes both a rigid and flexible contact surfaces that may be used with connector 200 instead of terminal 202 depicted in FIGS. 2-6. Terminal 302 is substantially similar to terminal 202 and includes a contact insert 316 including an array 340 of resilient positive and negative protrusions 318, 320 as described above with respect to array 240 of contact insert 216. Terminal 302 differs from terminal 202 in that it includes a pair of projections 304A, 304B that protrude from terminal 302 and extend through openings 324A, 324B in contract insert 316, and serve as rigid contact surfaces of connector 200. In the illustrated example, the projections 304A, 304B are embossments formed in the terminal 302 having a spherical sector or domed shape. In some examples, a height of the projections 304A, 304B of terminal 302 may be selected to limit compression of the array 340 of resilient positive and negative protrusions 318, 320 and thereby inhibit overstress of the array 340. According to the example terminal 302 of FIG. 7, projections 304A, 304B operate in conjunction with array 340 to establish a plurality of coupling points of connector, between the respective terminals 402, 226, as depicted in FIGS. 2 and 3.

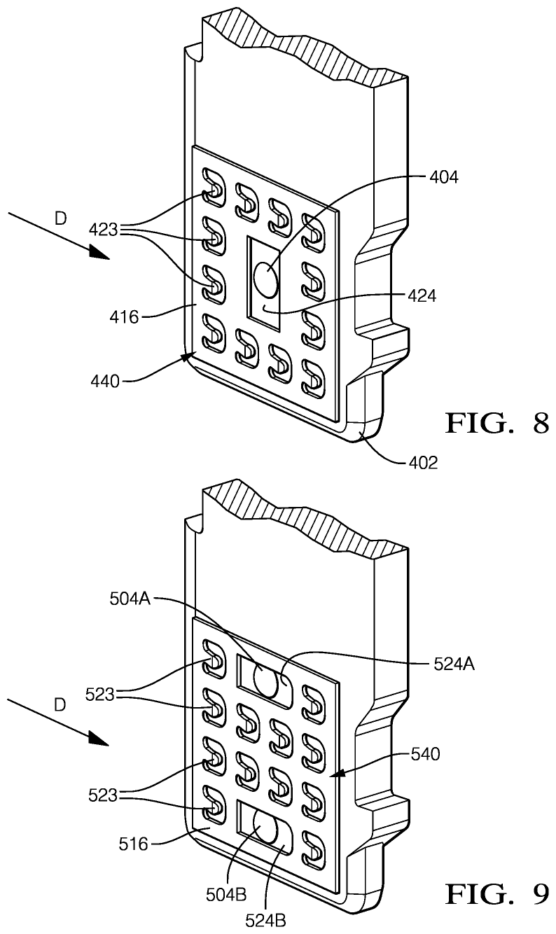

FIG. 8 depicts an alternative embodiment of a terminal 402 that includes both a rigid and flexible contact surfaces that may be used with connector 200 instead of terminal 202 depicted in FIGS. 2-6. Terminal 402 is substantially similar to terminal 202 depicted in FIGS. 2-6 and includes a projection 404 that extends through an opening 424 in a contact insert 416 and includes an array 440 of protrusions. The projection serves as a rigid contact surface, and the array of protrusions 440 serves as flexible contact surfaces that operate in conjunction with the rigid contact surface to establish a plurality of coupling points of connector, between the respective terminals 402, 226, as depicted in FIGS. 2 and 3.

Terminal 402 differs from terminal 202 in that contact insert 416 includes an array 440 of cantilevered protrusions 423. As shown in FIG. 8, the cantilevered protrusions 424 extend from contact insert 416 in a direction D consistent with an insertion direction of a mating terminal 226, as depicted in FIGS. 2 and 3. In some examples, the cantilevered protrusions 424 extend above a planar surface of contact insert 416, such that the protrusions 423 are depressed when connector 200 is mated, exerting a force in opposition to a normal force applied by spring 214 on the respective terminals 402, 226. In some examples, a height of the projection 404 of terminal 302 may be selected to limit compression of the array 440 of cantilevered protrusions 424 and thereby inhibit overstress of the array 440. According to the example terminal 402 of FIG. 8, projection 404 operates with array 440 of cantilevered protrusions 423 to establish a plurality of coupling points of connector, between the respective terminals 402, 226.

FIG. 9 depicts an alternative embodiment of a terminal 502 that includes both a rigid and flexible contact surfaces that may be used with connector 200 instead of terminal 202 depicted in FIGS. 2-6. Terminal 502 is substantially similar to terminal 402 depicted in FIG. 4 and includes an array 540 of cantilevered protrusions 523, which serve as a flexible contact surface of connector 200. Terminal 502 differs from terminal 402 in that it includes a pair of projections 504A, 504B that protrude from terminal 502, extend through openings 524A, 524B in contract insert 516, and serve as rigid contact surfaces of connector 200. In the illustrated example, the projections 504A, 504B are embossments formed in terminal 502 having a spherical sector or domed shape. In some examples, a height of the projections 504A, 504B of terminal 502 may be selected to limit compression of the array 540 cantilevered protrusions 523 and thereby inhibit overstress of the array 540. According to the example terminal 502 of FIG. 9, projections 504A, 504B operates with array 540 of cantilevered protrusions 523 to establish a plurality of coupling points of connector 200, between the respective terminals 502, 226, as depicted in FIGS. 2 and 3.

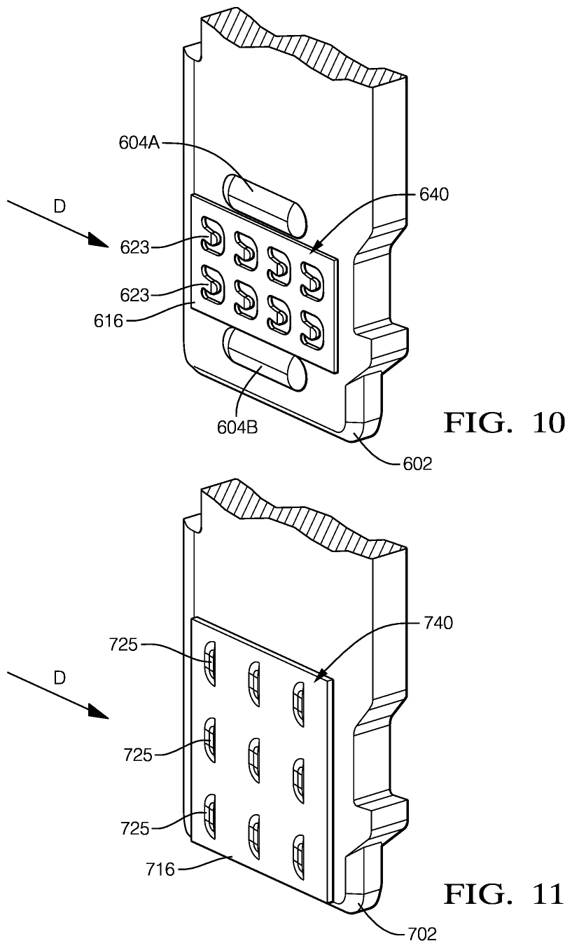

FIG. 10 depicts an alternative embodiment of a terminal 602 that includes both a rigid and flexible contact surfaces that may be used with connector 200 instead of terminal 202 depicted in FIGS. 2-6. Terminal 602 is substantially similar to terminal 502 depicted in FIG. 5 and includes an array 640 of cantilevered protrusions 623, which serve as a flexible contact surface of connector 200. Terminal 602 differs from terminal 502 in that it includes a pair of oval shaped projections 604A, 604B that protrude from terminal 602, extend through openings 624A, 624B in contract insert 616, and serve as rigid contact surfaces of connector 200. In the illustrated example, the projections 604A, 604B are embossments formed in the terminal 602 having a domed oval shape. In some examples, a height of the projections 604A, 604B of terminal 602 may be selected to limit compression of the array 640 cantilevered protrusions 623 and thereby inhibit overstress of the array 640. According to the example terminal 602 of FIG. 10, projections 604A, 604B operate with array 640 of cantilevered protrusions 623 to establish a plurality of coupling points of connector 200, between the respective terminals 602, 226, as depicted in FIGS. 2 and 3.

FIG. 11 depicts an alternative embodiment of a terminal 702 that includes both rigid and flexible contact surfaces that may be used with connector 200 instead of terminal 202 depicted in FIGS. 2-6. Terminal 702 is substantially similar to terminal 202 depicted in FIGS. 2-6. Terminal 702 differs from terminal 202 in that it includes a contact insert 716 that includes an array 740 of louvres 725. Louvres 725 may include a series of geometric contact points that are both rigid and flexible to allow for variable interference. In some examples, a shape of louvres can be modified to adapt for engage force, plating wear and tolerancing. For example, louvres 725 may include a flexible base with a pointed contact surface arranged to dig into terminal/plating of a corresponding mating terminal 226. In other examples, louvres 725 may be rounded and adapted to slip past terminal/plating of a corresponding mating terminal 226. In some examples, louvres 725 may be stamped to be more or less flexible as needed to reliably establish a plurality of contact points and at the same time establish a reliable electrical connection that is resilient to overstress.

As shown in the example of FIG. 11, terminal 702 does not include projections that serve as a rigid contact surface.

Referring again to connector 200 depicted in FIG. 2, various embodiments of contact inserts are described herein configured to improve a coupling between a terminal 202 of connector 200 and a mating terminal 226 of the connector 200. According to these various embodiments depicted, the respective contact inserts are coupling to terminal 202, for example via laser welding. In other example not depicted herein, the various contact inserts 216, 316, 416, 516, 616, 716 may be instead be coupled to mating terminal 226 and function similarly to improve a coupling between terminal 202 and mating terminal 226 of connector 200.

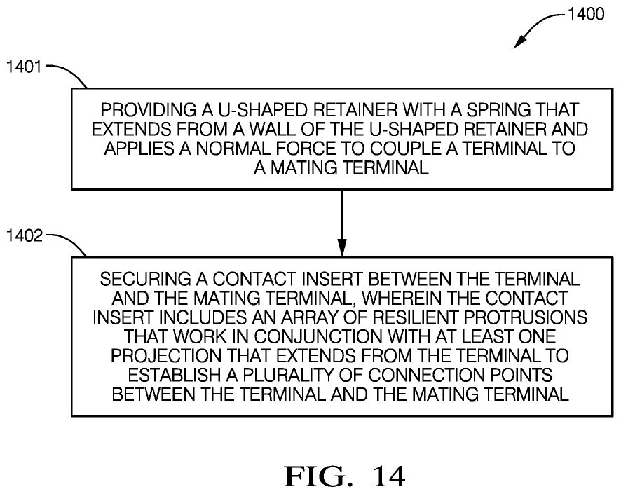

FIG. 14 is a flow diagram that depicts one example of a method 1400 of assembling an electrical connector according to some embodiments. As shown in FIG. 12, the method includes providing a U-shaped retainer with a spring that extends from a wall of the U-shaped retainer and applies a normal force to couple a terminal to a mating terminal (1401). As also shown in FIG. 12, the method further includes providing a contact insert that includes an array of resilient protrusions that operate in conjunction with at least one projection that extends from the terminal to establish a plurality of connection points between the terminal and the mating terminal (1402). In some examples, the contact insert includes an array (e.g., 240, 340) of positive and negative protrusions (e.g., 218-220, 318, 320) as depicted in the examples of FIGS. 3-7. In other examples, the contact insert includes an array (e.g., 440, 540, 640) of cantilever protrusions (e.g., 423, 523, 623) as depicted in the examples of FIGS. 8-10. In still other examples, the contact insert includes an array (e.g., 740) of louvred protrusions 725 as shown in the example of FIG. 11.

In some examples, the at least one projection serves as a rigid contact surface. As shown in the examples of FIGS. 6 and 8, a terminal may include a single projection (e.g. 204, 404) that extends through an opening (e.g., 224, 424) in the contact insert (e.g., 216, 416). As shown in FIGS. 7 and 9, a terminal may include a pair of projections (304A-304B, 504A-504B) that extend through respective pairs of openings (e.g., 324A-324B, 524A-524B) in the contact insert. As shown in FIG. 10, in other embodiments, a terminal (e.g., 602) include a plurality of projections 604A, 604B arranged on opposed sides of an array (e.g., 640) of resilient protrusions (e.g., 640).

In some examples, the array of resilient protrusions serve as flexible contact surfaces of the connector 200, and the at least one projection serves as a rigid contact surface of the connector 200. In other examples, such as terminal 702 depicted in FIG. 11, louvres 725 serve as rigid and flexible contact surfaces.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### CLAUSES

Clause 1. A high-voltage electrical connector (200), comprising: a U-shaped retainer (206); a spring (214) that extends from a wall of the U-shaped retainer and applies a normal force to couple a terminal (202, 302, 402, 502, 602) to a mating terminal (226) in the high voltage electrical connector (200); and a contact insert (216, 316, 416, 516, 616) configured to be arranged between the terminal (202, 302, 402, 502, 602) and the mating terminal (226), wherein the contact insert (216, 316, 416, 516) includes an array (240, 340, 440, 540, 640) of resilient protrusions that operate in conjunction with at least one projection (204, 304A-304B, 404, 504A-504B, 604A-604B) that extends from the terminal (202, 302, 402, 502, 602) to establish a plurality of connection points between the terminal and the mating terminal (226).

Clause 2. The electrical connector of claim 1, wherein the at least one projection (204, 304A-304B, 404, 504A-504B, 604A-604B) serves as a rigid contact surface of the high-voltage electrical connector (200), and wherein the array (240, 340, 440, 540, 640) of resilient protrusions serve as flexible contact surfaces of the high-voltage electrical connector (200).

Clause 3. The electrical connector of any of claims 1 and 2, wherein the contact insert (216, 316, 416, 516, 616) defines at least one opening (224, 324A-324B, 424, 524A-524B) through which the at least one projection (204, 304A-304B, 404, 504A-504B) extends through the contact insert.

Clause 4. The electrical connector of any of claims 1-3, wherein the at least one projection is a pair of projections (304A-304B, 504A-504B) that extend through respective openings (324A-324B, 524A-524B) in the contact insert.

Clause 5. The electrical connector of any of claims 1-4, wherein the array of resilient protrusions is an array (240, 340) of resilient positive and negative protrusions (218, 220, 318, 320).

Clause 6. The electrical connector of any of claims 1-4, wherein the array (440, 540, 640) of resilient protrusions is an array of cantilevered arms (423, 523, 623).

Clause 7. The electrical connector of claim 6, wherein the array (440, 540, 640) of cantilevered arms (423, 523, 623) extend in an insertion direction of the mating terminal (226).

Clause 8. The electrical connector of any of claims 1-4, wherein the array of resilient protrusions is an array (740) of louvres (725), and wherein the louvres each include a rigid contact surface and a flexible contact surface.

Clause 9. The electrical connector of any of claims 1-8, wherein the at least one projection comprises a first projection (604A) and a second projection (604B), and wherein the contact insert (616) is arranged between the first and second projections.

Clause 10. The electrical connector of any of claims 1-9, wherein a height of the at least one projection (204, 304A-304B, 404, 504A-504B, 604A-604B) is sized to limit compression of the array of resilient protrusions.

Clause 11. The electrical connector of any of claims 1-10, wherein the contact insert (216, 316, 416, 516, 616, 716) is welded to one of the terminal (202, 302, 402, 502, 602), or the mating terminal (226).

Clause 12. A bus bar terminal (202, 302, 402, 502, 602), comprising: a planar surface configured to be coupled with a mating terminal (226) by a connector (200) comprising a U-shaped retainer (206) with spring (214) that applies a normal force on the bus bar terminal (202, 302, 402, 502, 602 and the mating terminal (226); and a contact insert (216, 316, 416, 516, 616) secured to the planar surface that includes an array (240, 340, 440, 540, 640) of resilient protrusions that operate in conjunction with at least one projection (204, 304A-304B, 404, 504A-504B, 604A-604B) that extends from planar surface to establish a plurality of connection points between the bus bar terminal (202, 302, 402, 502, 602) and the mating terminal (226).

Clause 13. The bus bar terminal of claim 15, wherein the at least one projection (204, 304A-304B, 404, 504A-504B, 604A-604B) serves as a rigid contact surface of the connector (200), and wherein the array (240, 340, 440, 540, 640) of resilient protrusions serve as of flexible contact surfaces of the connector.

Clause 14. The bus bar terminal of claim 14, wherein the array of resilient protrusions is an array (220, 320) of resilient positive and negative protrusions (218, 220, 318, 320).

Clause 15. The bus bar terminal of claim 15, wherein the array of resilient protrusions is an array (440, 540, 640) of cantilevered arms (423, 523, 623).

Clause 16. The bus bar terminal of claim 1, wherein a height of the at least one projection (204, 304A-304B, 404, 504A-504B, 604A-604B) is sized to limit compression of the array (240, 340, 440, 540, 640) of resilient protrusions.

Clause 17. A method of assembling an electrical connector (200), comprising: providing a U-shaped retainer (206) with a spring (214) that extends from a wall of the U-shaped retainer (206) and applies a normal force to couple a terminal (202, 302, 402, 502, 602) to a mating terminal (226); and arranging a contact insert (216, 316, 416, 516, 616) between the terminal (202, 302, 402, 502, 602) and the mating terminal (226), wherein the contact insert includes an array (240, 340, 440, 540, 640) of resilient protrusions that operate in conjunction with at least one projection (204, 304A-304B, 404, 504A-504B, 604A-604B) that extends from the terminal (202, 302, 402, 502, 602) to establish a plurality of connection points between the terminal (202, 302, 402, 502, 602) and the mating terminal (226).

Clause 18. The method of claim 17, wherein the at least one projection (204, 304A-304B, 404, 504A-504B, 604A-604B) serves as a rigid contact surface of the electrical connector (200), and wherein the array of resilient protrusions (240, 340, 440, 540, 640) serve as flexible contact surfaces of the electrical connector (200).

Clause 19. The method of claim 17, wherein the array of resilient protrusions is an array (220, 320) of resilient positive and negative protrusions (218, 220, 318, 320).

Clause 20. The method of claim 17, wherein the array of resilient protrusions is an array (440, 540, 640) of cantilevered arms (423, 523, 623).

1. A high-voltage electrical connector, comprising:
a U-shaped retainer;
a spring that extends from a wall of the U-shaped retainer and applies a normal force to couple a terminal to a mating terminal in the high voltage electrical connector; and
a contact insert configured to be arranged between the terminal and the mating terminal, wherein the contact insert includes an array of resilient protrusions that operate in conjunction with at least one projection that extends from the terminal to establish a plurality of connection points between the terminal and the mating terminal.

2. The high-voltage electrical connector of claim 1, wherein the at least one projection serves as a rigid contact surface of the high-voltage electrical connector, and wherein the array of resilient protrusions serve as flexible contact surfaces of the high-voltage electrical connector.

3. The high-voltage electrical connector of claim 1, wherein the contact insert defines at least one opening through which the at least one projection extends through the contact insert.

4. The high-voltage electrical connector of claim 3, wherein the at least one projection is a pair of projections that extend through respective openings in the contact insert.

5. The high-voltage electrical connector of claim 1, wherein the array of resilient protrusions is an array of resilient positive and negative protrusions.

6. The high-voltage electrical connector of claim 1, wherein the array of resilient protrusions is an array of cantilevered arms.

7. The high-voltage electrical connector of claim 6, wherein the array of cantilevered arms extend in an insertion direction of the mating terminal.

8. The high-voltage electrical connector of claim 1, wherein the array of resilient protrusions is an array of louvres, and wherein the louvres each include a rigid contact surface and a flexible contact surface.

9. The high-voltage electrical connector of claim 1, wherein the at least one projection comprises a first projection and a second projection, and wherein the contact insert is arranged between the first and second projections.

10. The high-voltage electrical connector of claim 1, wherein a height of the at least one projection is sized to limit compression of the array of resilient protrusions.

11. The high-voltage electrical connector of claim 1, wherein the contact insert is welded to one of the terminal or the mating terminal.

12. A bus bar terminal, comprising:
a planar surface configured to be coupled with a mating terminal by a connector comprising a U-shaped retainer with a spring that applies a normal force on the bus bar terminal and the mating terminal; and
a contact insert secured to the planar surface that includes an array of resilient protrusions that operate in conjunction with at least one projection that extends from the planar surface to establish a plurality of connection points between the bus bar terminal and the mating terminal.

13. The bus bar terminal of claim 12, wherein the at least one projection serves as a rigid contact surface of the bus bar terminal, and wherein the array of resilient protrusions serve as flexible contact surfaces of the bus bar terminal.

14. The bus bar terminal of claim 13, wherein the array of resilient protrusions is an array of resilient positive and negative protrusions.

15. The bus bar terminal of claim 14, wherein the array of resilient protrusions is an array of cantilevered arms.

16. The bus bar terminal of claim 12, wherein a height of the at least one projection is sized to limit compression of the array of resilient protrusions.

17. A method of assembling an electrical connector, comprising:
providing a U-shaped retainer with a spring that extends from a wall of the U-shaped retainer and applies a normal force to couple a terminal to a mating terminal; and
arranging a contact insert between the terminal and the mating terminal, wherein the contact insert includes an array of resilient protrusions that operate in conjunction with at least one projection that extends from the terminal to establish a plurality of connection points between the terminal and the mating terminal.

18. The method of claim 17, wherein the at least one projection serves as a rigid contact surface of the electrical connector, and wherein the array of resilient protrusions serve as flexible contact surfaces of the electrical connector.

19. The method of claim 17, wherein the array of resilient protrusions is an array of resilient positive and negative protrusions.

20. The method of claim 17, wherein the array of resilient protrusions is an array of cantilevered arms.
